(19) United States
(12) Patent Application Publication
(10) Pub. No.: US 2007/0095115 A1
(43) Pub. Date: May 3, 2007

(54) Lock

(76) Inventor: Ulrich Bantle, Empfingen (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 10/560,148

(22) PCT Filed: Nov. 27, 2004
(86) PCT No.: PCT/EP04/13504

§ 371 Date: Dec. 7, 2005

(30) Foreign Application Priority Data
Dec. 19, 2003 (DE) 103 59 758.1

(51) Int. Cl. E05B 47/00

(52) U.S. Cl. 70/276

(57) ABSTRACT

A lock with a bolt, arranged in a lock housing. The bolt may be adjusted between an open and a closed position, by a closing element, and the closing element may be locked in a closed position, by a locking element. The locking element is coupled to an armature of an electromagnet and may be operated by the same. For better protection against manipulation for such a lock, the armature and/or the electromagnet are at least partly covered by at least one screening element, arranged in, or on the housing, which can be made from a soft magnetic material.

### BACKGROUND OF THE INVENTION

1. Field of the Invention

This invention relates to a lock with a bolt arranged in a lock housing, wherein the bolt can be shifted between an opened position and a closed position by a closing element, in the closing position the closing element can be blocked by a blocking element, and the blocking element is coupled with an armature of an electromagnet and can be actuated by the armature.

2. Discussion of Related Art

A lock is known from U.S. Pat. No. 1,721,730. The electromagnet is coupled to a lever mechanism by an armature. The lever mechanism supports the blocking element. A push bar lock can be released or blocked by the blocking element. A danger of unauthorized manipulation exists with such locks. It is thus possible to shift the armature of the electromagnet from the outside of the locked door by a strong permanent magnet. This is possible particularly with rare earth magnets, which build up a strong magnetic field. If the armature is brought out of engagement with the locking element in this way, it is then possible to open the door.

### SUMMARY OF THE INVENTION

It is one object of this invention to provide a lock of the above mentioned type but which offers increased protection against unauthorized manipulation.

This object is attained if an armature and/or the electromagnet are covered, at least over portions, by at least one shielding element made of a low-retentive magnetic material arranged on or in the housing.

The shielding element made of a low-retentive magnetic material, for example iron, bundles the magnetic field emanating from the magnet used for the manipulation. Thus, the armature and/or the electromagnet are protected in a simple manner. Because the shielding element is directly associated with the housing, no additional installation cost outlay for shielding is created when assembling the lock.

In accordance with one embodiment of this invention, the housing has a connecting side on which lock operating elements, such as a keypad or grille, are arranged, and the shielding element is arranged in the area of or near the housing facing the connecting side. With its connecting side the lock can be installed on the inside of a door of a locker, for example. This connecting side is protected against the interfering action.

A structurally simple lock design results if the housing is closed by a cover, and the cover supports the shielding element on its side facing the housing interior.

In order to achieve effective shielding even against very strong magnets, the shielding element can be formed by a sheet metal plate with a wall thickness of at least 0.8 mm. The shielding element can also be directly installed on the electromagnet for achieving effective protection.

An additional function is assigned to the armature, if the armature or the blocking element supports a switching element which actuates a contactless switch. The contactless switch can monitor the blocking state of the blocking element. Because of the use of a contactless switch, no or only slight switching forces for the performance of the switching process are created. Accordingly, the electromagnet need not have any additional switching power, so that it can be operated with a low output of energy. This has a positive effect, particularly if a battery-generated current supply is used for the lock.

Thus, the armature or the blocking element has a permanent magnet as the switching element, by which a change of the switching state of the contactless switch, which is embodied as a reed contact, can be performed. To prevent unauthorized influencing of the reed contact, the reed contact can be arranged in the area of or near the shielding element.

In one possible lock variation, a permanent magnet which maintains the armature in its opening state is assigned to the armature. A magnetic force which acts counter to the force of the permanent magnet can be applied to the armature by the electromagnet, and a spring is assigned to the armature which, in the open state, applies a spring force acting on the armature in the closing direction. With this lock layout it is possible to employ an electromagnet acting in one direction, which makes possible a low energy requirement.

### BRIEF DESCRIPTION OF THE DRAWINGS

This invention is explained in greater detail in view of an exemplary embodiment represented in the drawings, wherein:

FIG. 1 shows a lock in a lateral view, along a section line shown in FIG. 2;

FIG. 2 shows the lock in accordance with FIG. 1, in a top view;

FIGS. 3 to 6 show flow diagrams representing the procedure for operating the lock.

### DESCRIPTION OF PREFERRED EMBODIMENTS

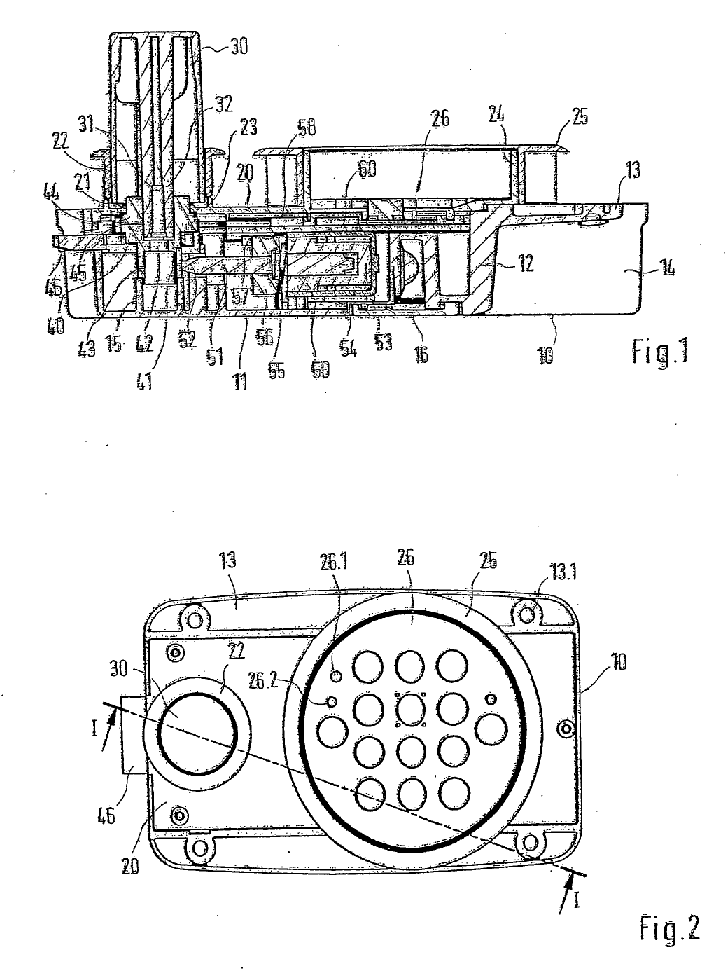

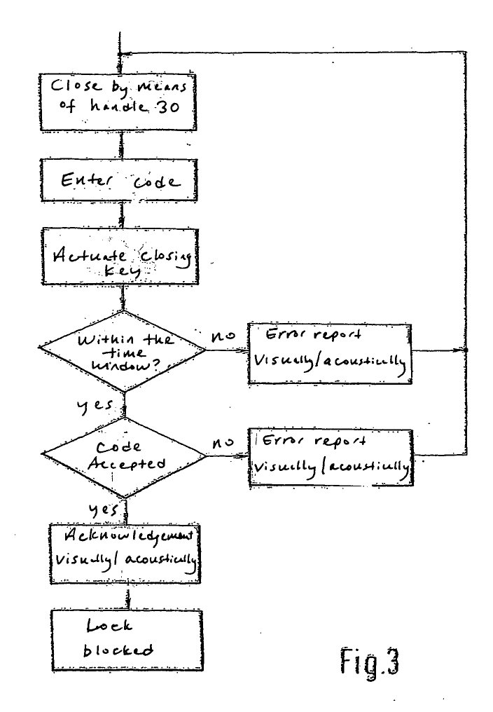

A lock with a housing 10 is shown in FIG. 1. The housing 10 has a bottom 11, from which lateral walls 11 arise all around. At the top as shown in FIG. 1, the housing 10 forms a connecting side. There, the housing 10 is closed off by a screwed on cover 20. As revealed in FIG. 2, the housing 10 has two fastening flanges 13 with fastening receivers 13.1 on the sides of the cover 20. With these the lock can be screwed on the inside of a door, flap or the like, for example.

The cover 20 has a ring-shaped rose holder 24, which surrounds a keypad field. A keypad 26, for example a silicon switching plate, is fastened to the rear of the cover 20 and protrudes with its keys through openings in the cover 20. Also, at least one LED 26.2, which indicates the operational states of the lock, is assigned to the keypad 26. Furthermore, a line jack 26.1 is integrated into the keypad 26. With this, the presently battery-powered lock can have electrical current if the battery fails. The line jack 26.1 is advantageously integrated into the silicon switching plate as a predetermined breaking point. If needed, a plug can be pushed through the predetermined breaking point and electrical current can be supplied externally. Following the removal of the plug, the hole seals itself because of the inherent elasticity of the created hole. A removable compartment cover 16 is provided on a side of the lock facing away from the connecting side and covers a battery compartment 14, in which the batteries that provide the lock with electrical current are maintained. A rose 25 is pushed onto the rose holder 24 shown in FIG. 1. The rose holder 24 protrudes into an opening of the connected door. The rose 25 is inserted from the front of the door and covers an edge of the opening with a radially protruding flange.

A support section 23, which extends annularly and surrounds a bearing receiver 21 of the cover 20, is formed on the cover 20. A rose 22 can be pushed on a handle 30. Then the rose 22 is arranged above the support section 23. The rose 22 is used for covering an edge of a circle-shaped opening in the door, through which the handle 30 has passed. The rose 22 is continuously adjustable with respect to the handle 30 in an assigned bore receptacle of a door, and the rose 25 on the rose holder 24, for matching different door thicknesses.

The handle 30 is connected with a locking element 40. The handle 30 is inserted with a plug-in shoulder 32 into a plug-in receptacle 45 of the locking element 40. The locking element 40 has a screw receptacle 42 aligned with a threaded receiver 31 of the handle 30. A screw can be passed through the screw receptacle 42 and screwed into the threaded receiver 31.

The locking element 40 is rotatably maintained with a first bearing shoulder 43 on a bearing 15 of the housing 10, and with a second bearing shoulder 44 in the bearing receiver 21 of the cover 20. The locking element 40 can be rotated around the bearing axis, which extends vertically in FIG. 1.

The locking element 40 engages with a bolt 46 that can be moved between an opened and a closed position in a slide guide of the housing 10 by the locking element 40. FIG. 1 shows the opened position with the bolt 46 retracted. In FIG. 2 the bolt 46 is extended from the housing 10.

As FIG. 1 shows, the locking element 40 has an arresting receptacle 41, which is arranged in the form of a radially accessible recess in the area of or near the bearing shoulder 43. A blocking element, which is a part of an armature 51 of an electromagnet 50, is assigned to the arresting receptacle 41. The electromagnet 50 is maintained in the housing 10 and can be activated by the battery. The electromagnet 50 pushes the armature 51 out and, from the opened position shown in FIG. 1, reaches the blocking position, in which the blocking element 52 engages the arresting receptacle 41. The electromagnet 50 has a permanent magnet 53. In the currentless state of the electromagnet 50, it maintains the armature 51 in the initial position illustrated in FIG. 1. When the electromagnet 50 is activated, the armature 51 is pushed away from the permanent magnet 53. For saving electrical current, the electromagnet 50 is only briefly provided with electrical current. This is already sufficient for lifting it slightly off the permanent magnet 53. Then a spring 55, which prestresses the armature 51 in the closing position, pushes the armature 51 into the arresting receptacle 41.

The electromagnet 50 is surrounded by a hoop-shaped shielding element 54 made of a low-retentive magnetic material that provides shielding against magnetic radiation acting from the outside.

FIG. 1 further discloses that the armature 51 supports a permanent magnet 56 which, in the form of a ring, is pushed onto the armature 51, which is round in cross section. A reed contact as a contactless switch 57, which is fastened on a plate 60, is assigned to the permanent magnet 56. Together with the armature 51, the permanent magnet 56 is moved between two positions. It then also moves the reed contact into different switching positions.

A further shielding element 58 is provided on the inside of the cover 20 and is made in the form of a 1 mm thick plate of a low-retentive magnetic material. The shielding element 58 shields the armature 51 in the transition area to the electromagnet 50 and prevents the effects of magnetic radiation from the direction of the connecting side. The plate 60 receives the electric switching devices of the lock and receives the reed contact, a micro-controller and the switches which can be actuated by the keys of the keypad 26.

An operation and functioning of the lock is explained in greater detail in view of FIGS. 3 to 6.

The procedure for closing the lock is explained in greater detail in FIG. 3. First, the handle 30 and the locking element 40 is rotated. During this, the arresting receptacle 41 is assigned to the blocking element 52. Subsequently it is possible to input a code, limited to a specified number, for example with four digits, which is freely selected by the user and can be acknowledged by a locking key of the keypad 26.

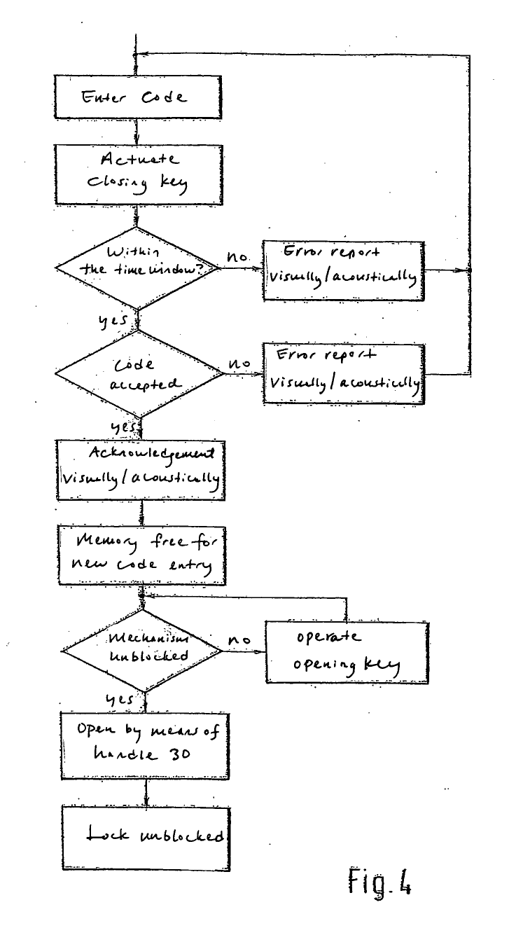

The control circuit arranged on the plate 60 is triggered via the locking key, so that it activates the electromagnet 50 by a short electrical current pulse that pushes the armature 51 away from the permanent magnet 53. Then the spring 55 pushes the armature 51, together with its blocking element 52, into the arresting receptacle 41. As shown in FIG. 3, two control stages, small diamond-shaped boxes, are programmed and check whether the locking key is actuated within a pre-specified time window, and whether the code is admissible. In addition, the reed switch checks whether the armature 51 is switched into the closed position. Only then is the code dependably stored. FIG. 4 describes the process for opening the lock. Accordingly, the code pre-specified in accordance with FIG. 3 is entered and an opening key is then pushed. If the opening key is actuated within a pre-specified time window and the correct code has been entered, the memory of the control circuit is released for the renewed entry of a code after an acknowledgement signal is issued. The opening key simultaneously activates an electrical circuit in the control circuit, which activates the electromagnet 50 so that the armature 51 is moved out of the arresting receptacle 41. In the process, the armature 51 is moved counter to the force of the spring 55 against the permanent magnet 53 and is then held by it. This position is represented in FIG. 1. If the armature 51 does not move back correctly, for example, because the lock is jammed, the user can again operate the opening key. During this an extended electrical current pulse is applied to the electromagnet 50. The reed contact or contactless switch 57 signals that the mechanism is unlocked. Then the lock can be unlocked by the handle 30. Thus, the handle is rotated so that the bolt 46 enters the housing 10.

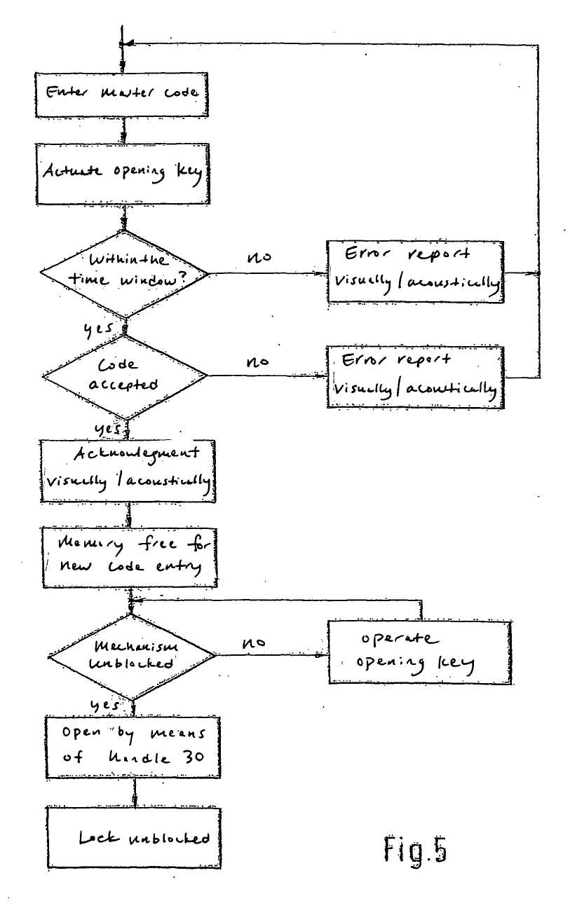

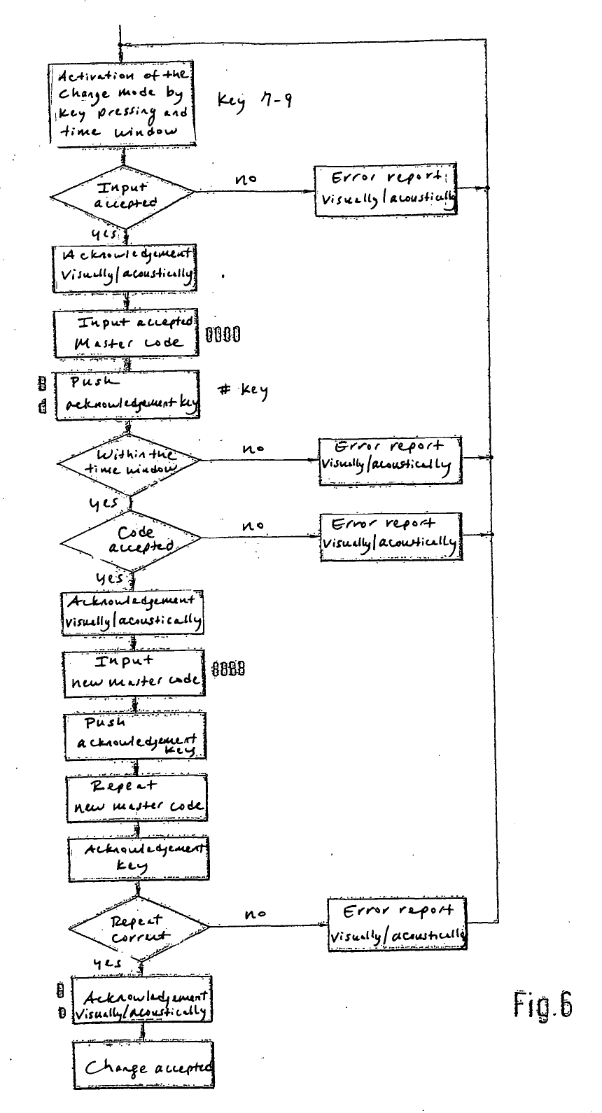

FIG. 5 shows the procedure for opening the lock by a master code. As the representation shows, the sequence is selected analogous to the routine shown in FIG. 4. A flow diagram is shown in FIG. 6, which shows the procedure for re-programming the master code. Changing the master code is possible in the opened, as well as in the locked state of the lock.

So that the lock can also be opened if the master code is lost, the control circuit can be set as a freely definable handling code.

For making optimum use of the life of the batteries, the lock has an energy circuit which is activated if the lock is not operated within a pre-specified time window. Switching from the economy mode into the operating mode occurs as soon as a key of the keypad 26 is actuated.

1. A lock with a bolt arranged in a lock housing, wherein the bolt can be shifted between an opened position and a closed position by a closing element, wherein in the closing position the closing element can be blocked by a blocking element, and the blocking element is coupled with an armature of an electromagnet and can be actuated by the armature, the lock comprising:
at least one of the armature (51) and the electromagnet (50) at least partially covered by at least one shielding element (54, 58) made of a low-retentive magnetic material arranged one of on and in the housing (10).

2. The lock in accordance with claim 1, wherein the housing has a connecting side on which lock operating elements are arranged, and the shielding element (58) is positioned near a housing facing the connecting side.

3. The lock in accordance with claim 2, wherein the housing is closed (10) by a cover (20), and the cover (20) supports the shielding element (58) on a side facing the housing interior.

4. The lock in accordance with claim 3, wherein the shielding element (58) is formed by a sheet metal plate having a wall thickness of at least 0.8 mm.

5. The lock in accordance with claim 4, wherein the electromagnet (50) supports the shielding element (54).

6. The lock in accordance with claim 5, wherein one of the armature (51) and the blocking element (52) supports a switching element which actuates a contactless switch (57).

7. The lock in accordance with claim 6, wherein one of the armature (51) and the blocking element (52) has a permanent magnet (56) as the switching element by which a change of the switching state of the contactless switch (57) which is a reed contact can be performed.

8. The lock in accordance with claim 7, wherein a permanent magnet (53) is assigned to the armature (51), which maintains the armature (51) in an opening state, a magnetic force is applied to the armature (51) by the electromagnet (50) which acts counter to a force of the permanent magnet (53), and a spring (55) is assigned to the armature (51) which in the open state applies a spring force acting in a closing direction to the armature (51).

9. A lock with a bolt, which can be placed into a locking position and an opening position by a control knob and an actuating element, wherein a blocking armature is assigned to the actuating element, which can be brought into the blocking position by an electrically controllable magnet and can be returned into a release position, the lock comprising:
a control device which can be adjusted by a keypad (26) assigned to the magnet and in which code information is storable which, in case of a renewed input and after being checked by the stored code information, is used for controlling the magnet.

10. (canceled)

11. The lock in accordance with claim 1, wherein the housing is closed (10) by a cover (20), and the cover (20) supports the shielding element (58) on a side facing the housing interior.

12. The lock in accordance with claim 1, wherein the shielding element (58) is formed by a sheet metal plate having a wall thickness of at least 0.8 mm.

13. The lock in accordance with claim 1, wherein the electromagnet (50) supports the shielding element (54).

14. The lock in accordance with claim 1, wherein one of the armature (51) and the blocking element (52) supports a switching element which actuates a contactless switch (57).

15. The lock in accordance with claim 14, wherein one of the armature (51) and the blocking element (52) has a permanent magnet (56) as the switching element by which a change of the switching state of the contactless switch (57) which is a reed contact can be performed.

16. The lock in accordance with claim 1, wherein a permanent magnet (53) is assigned to the armature (51), which maintains the armature (51) in an opening state, a magnetic force is applied to the armature (51) by the electromagnet (50) which acts counter to a force of the permanent magnet (53), and a spring (55) is assigned to the armature (51) which in the open state applies a spring force acting in a closing direction to the armature (51).
